(19) United States
(12) Patent Application Publication
(10) Pub. No.: US 2009/0262335 A1
(43) Pub. Date: Oct. 22, 2009

(54) HOLOGRAPHIC SCATTEROMETER

(76) Inventor: Vladimir Alexeevich UKRAINTSEV, Allen, TX (US)

Correspondence Address: TEXAS INSTRUMENTS INCORPORATED, P O BOX 655474, M/S 3999, DALLAS, TX, 75265, US

(21) Appl. No.: 12/107,534

(22) Filed: Apr. 22, 2008

(51) Int. Cl. G01N 21/00

(52) U.S. Cl. 356/73

(57) ABSTRACT

Exemplary embodiments provide a system and method for holographic scatterometry by using holography in a scatterometry system to record amplitude and phase of scattered light from a featured object in order to measure geometries and/or feature dimensions of the object. The amplitude and phase information can be obtained simultaneously and instantaneously in a single tool with incident and azymuthal angular resolution. Specifically, the holographic scatterometry can include a splitter for producing two coherent beams including a test beam and a reference beam. The test beam can be focused on and scattered, diffracted and/or reflected from the featured object and interfered with the reference beam on an image sensor (e.g., a charge-coupled device (CCD) camera). The resulting holographic information on the camera plane can include all angular amplitude and phase information of the scattered light from the measured object. The holographic scatterometry can thus include a combined power of angular reflectometry and ellipsometry.

### DESCRIPTION OF THE INVENTION

1. Field of the Invention

This invention generally relates to a scatterometry system and, more particularly, to a holographic scatterometry system

2. Background of the Invention

Over the past several years, there has been considerable interest in using optical scatterometry (i.e., optical diffraction) to perform measurements associated with semiconductor fabrication. One area of great interest has been the critical dimension (CD) measurements of two-dimensional structures (e.g., line gratings) and three-dimensional structures (e.g., patterns of vias or mesas) included in integrated circuits. Scatterometry measurements have also been proposed for monitoring etching, planarity of a polished layer, control of gate electrode profiles, film stack fault detection, stepper control, deposition process control and resist thickness control.

Various optical techniques have been used to perform optical scatterometry. These techniques include spectral ellipsometry (i.e., measuring phase and amplitude of the scattered light for fixed glanced incident and azymuthal angle), normal incidence spectral reflectometry (i.e., measuring amplitude of the scattered light for spectrum of wavelengths) and angular reflectometry (i.e., measuring amplitude of the scattered light for spectrum of incident angles). These conventional scatterometry techniques have been used for the 45 nm semiconductor technology node. However, with the downsizing of scatterometry target (e.g., total area or number of features used to scatter light) and feature dimensions (e.g., height and lateral dimensions), the signal-to-noise ratio for scatterometry measurements significantly reduces with each technology node.

Attempts have also been made to combine various optical scatterometry techniques in order to obtain both phase and amplitude information of the scattered light from the measurement target for multiple incident and azymuthal angles. This requires combining different scatterometry techniques and different data libraries together as well as requires an additional challenging analysis for finding the best match from multiple (at least two) data libraries In addition, due to the difference between optical schemes used for the scatterometry, it is a challenge to combine them in a single tool.

Thus, there is a need to overcome these and other problems of the prior art and to provide a scatterometry system that can be used in a single tool to measure both phase and amplitude information for spectrum of incident and azymuthal angles.

### SUMMARY OF THE INVENTION

According to various embodiments, the present teachings include a method for holographic scatterometry. The holographic scatterometry can be performed by first providing a test light that is coherent with a reference light and is directed to emerge from a test object, followed by bringing the emerged test light and the reference light together on an image sensor to record the holographic information. Such holographic information can include the amplitude information and the phase information of the emerged test light from the test object.

According to various embodiments, the present teachings also include a method for holographic scatterometry. In this method, the amplitude and the phase of a test light that is caused to emerge from a test object can be simultaneously recorded as a holographic pattern using a CCD camera. On the CCD camera, the test light can interfere with a reference light that is derived from a common source with the test light. The recorded holographic pattern can then be compared with a data library to determine a topographic feature of the test object.

According to various embodiments, the present teachings further include a holographic scatterometry that includes a beam splitter. The beam splitter can split an incident light into a reference light and a test light, which is focused on and scattered from a test object. The holographic scatterometry can further include a CCD camera that is placed on a focal plane of where the scattered test light interferes with the reference light to simultaneously and instantaneously record the amplitude and the phase of the scattered test light from the test object.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts an exemplary holographic scatterometry system in accordance with the present teachings.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. The term “at least one of” is used to mean one or more of the listed items can be selected.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

Exemplary embodiments provide a system and method for holographic scatterometry by using holography in scatterometry to record amplitude and phase of scattered light from a featured object in order to measure the surface topography and/or feature dimensions of the object. The amplitude and phase information can be obtained simultaneously and instantaneously in a single tool with incident and azymuthal angular resolution.

Specifically, the disclosed holographic scatterometry can include a beam splitter to produce two coherent beams including a test beam and a reference beam. The test beam can be focused on and emerged (e.g., scattered, diffracted and/or reflected) from the featured object and interfered with the reference beam on an image sensor (e.g., a charge-coupled device (CCD) camera). When the reference light and the scattered light are coherent, due to the superposition of the light waves, optical interference between the lights can produce a series of intensity fringes that can be recorded as hologram (or interferogram) on the exemplary CCD camera, which is in focal plane of light collection optical system from the sample object. The resulting holographic information on the camera plane can include all angular (including azymuthal) amplitude and phase information of the scattered light from the measured object.

The holographic scatterometry can thus provide many advantages as compared with conventional optical scatterometry techniques, for example, ellipsometry. As compared, in one aspect, ellipsometry techniques provide dependent or limited amplitude and phase information. This is because ellipsometry measures the change of polarization (which is in turn determined by the sample properties, e.g., thickness, complex refractive or dielectric function tensor) by measuring the ratio or difference of amplitude and phase rather than the absolution value of either. In another aspect, ellipsometry techniques provide restricted or no angular information for phase nor for amplitude. In general, ellipsometry is restricted on one set of amplitude ratio and phase shift per measurement, which covers a fixed spectral range. In addition, conventional optical scatterometry techniques often measure only one of the phase and amplitude in one single tool. For example, angular reflectometry is used to measure amplitude of the scattered/reflected light from the test sample for spectrum of incident angles.

The disclosed holographic scatterometry can be used to measure both amplitude and phase of scattered test light simultaneously and instantaneously for all angles of incidence and all azymuthal angles recorded in the form of hologram (or interferogram) in focal plane of light collection optical system. That is, the holographic information can present scattered light characteristic averaged over scatterometry target of repeated periodic measured objects. In addition, instant amplitude and phase angular (including azymuthal) distribution of scattered light can be provided by the hologram, which can avoid analyzing time-components of the scattered test light (e.g., in order to extract angular dependences) and avoid varying incident angles.

Analyzing time-components of the signal is often used in conventional optical scatterometry, such as, in ellipsometry or interferometry. For example, in general, ellipsometry includes an incident light that is polarized by a polarizer After the incident light is scattered/ reflected from the sample, it passes a second polarizer as an analyzer and then falls into a detector. In ellipsometry, one needs to rotate incident light polarization or characterizers to analyze polarization and to read phase of the scattered light. In another example for interferometry, typically, an incident light is split into two (or more) coherent beams, which travel different paths, and the beams are then combined to create interference and the differences between the beams are detected. When the two beams have the same frequency that have the same phase, they add to each other and interfere constructively to increase the amplitude of the output wave. When the two beams have opposite phase, they subtract to decrease the amplitude of the output. Thus anything that changes the phase of one of the beams by 180°, shifts the interference from a maximum to a minimum. This makes interferometers sensitive measuring instruments for anything that changes the phase of a beam, such as path length or refractive index. For example, time components need to be analyzed from varying path of the two coherent beams.

The holographic scatterometry can thus include a combined power of, e.g., angular reflectometry and ellipsometry, to measure both amplitude and phase of scattered test light simultaneously and instantaneously for all incident and azymuthal angles without analyzing time components as used for other optical scatterometry techniques in the art. Further, by a simple comparison with a single scatterometric data library, the topographic feature information of the measured object can be obtained and there is no need to generate two libraries, e.g., for both angular reflectometry and ellipsometry, as that used in the prior art.

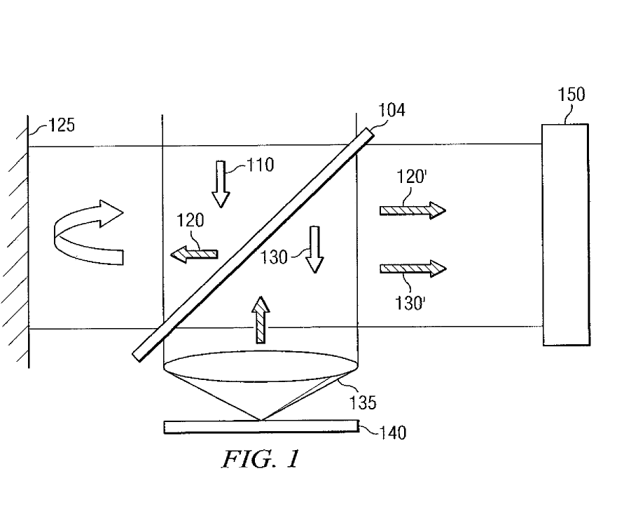

FIG. 1 depicts an exemplary holographic scatterometry system in accordance with the present teachings. It should be readily apparent to one of ordinary skill in the art that the holographic scatterometry system depicted in FIG. 1 represents a generalized schematic illustration and that other optical and/or non-optical components can be used and added or existing optical and/or non-optical components can be removed or modified. In addition, note that FIG. 1 uses a “Linnik-type” optical scheme as an example to describe and illustrate the disclosed holographic scatterometry. One of ordinary skill in the art will understand that other types of optical schemes including, but not limited to, Mirau-type, and Michelson-type, can be employed for the disclosed holographic scatterometry system.

The exemplary scheme shown in FIG. 1 can include a beam splitter 104, an incident light 110, a reference light 120, a mirror 125, a measurement light 130, an optical system 135, a test sample 140, and an image sensor 150.

The incident light 110 can be illuminated from an optical source (not shown), such as, for example, lasers, mercury-arc lamps or other optical sources. The incident light 110 can also be a white light or any monochromatic light, for example, blue, green, yellow, red, etc. The incident light 110 can have various incident angles and/or various wavelengths.

The incident light 110 can be partially reflected by the beam splitter 104 to define the reference light 120 and partially transmitted by the beam splitter 104 to define the measurement light 130. The measurement light 130 can be focused by the optical system 135 onto the test sample 140. The optical system 135 can be an objective to process the measurement light 130 that is transmitted from the beam splitter 104. The test sample 140 can be any featured object to be examined in-line or off-line from, e.g., a semiconductor manufacturing. For example, the disclosed holographic scatterometry can be used for, such as linewidth measurements, resist thickness measurements, overlay measurements, or side wall spacer analysis for transistor devices.

The measurement light 130 can be scattered, diffracted, and/or reflected from the test sample 140 at various angles, propagated back through the measurement optical system 135 resulting in an emerged light 130′, and reflected by the beam splitter 104 whereby resulting in a test light 130″. Similarly, reference light 120 can be reflected from the mirror 125, and transmitted through the beam splitter 104 as a reference light 120″ that is interfered with the test light 130″, whereby imaged and recorded by the image sensor 150. In various embodiments, the reference light 120 can be focused by a second optical system, e.g., a reference objective (not shown) having common properties (e.g., matched numerical apertures) with the exemplary objective 135, onto the mirror 125.

The image sensor 150 can be a charge-coupled device (CCD) camera and can be placed in the focal plane of a light collection optical system (not shown) of the interfered coherent lights 130″ and 120″ as shown in FIG. 1. Holographic information for a complete set of both amplitude and phase of the scattered light can be measured simultaneously and instantaneously for all angles of incidence and all azymuthal angles on the camera plane. The collected holographic information can include integrated information from all points of the test sample 140, and every point on the CCD screen 150 can point to a certain incident angle. In addition, angular distribution of the scattered/emerged test light 130″ can be collected on the CCD screen 150. The holographic scatterometry can therefore provide incident and azymuthal angular resolution with no spatial resolution provided.

Angular resolution is important for scatterometry applications. This is because the scattered test light in scatterometry often can have a strong signal in a direction that is perpendicular to the incident plane, i.e., out of phase of the incident plane, instead of in phase of the incident plane. In addition, with rapid development of technologies, more complex features and/or geometries can be introduced and used in, for example, semiconductor industries. The complexity of the test structure may scatter the test light in unexpected directions when using scatterometry to measure, e.g., feature sizes and/or critical dimensions. Holographic scatterometry, however, can provide an ability to collect scattered information not only in the incident plane but also in all azymuthal directions. In this manner, holographic scatterometry can differ from conventional scatterometry, where the detector screen is placed in an image plane (e.g., as opposed to the focal plane for holographic scatterometry); sample images (e.g., as opposed to the holographic information) are therefore obtained on the detector plane; and azymuthal angles are not identified to provide angular resolution.

Additionally, incident and azymuthal angular resolution can improve the quality of the scatterometry. For example, angular resolution can improve the signal-to-noise ratio of the disclosed scatterometry. In general, scatterometry utilizes a large target to collect sufficient information from similar structures and average the collected information in order to improve the signal-to-noise properties. Averaged information about structures from the test sample can then be extracted. Due to angular resolution of the holographic scatterometry, the averaged information (e.g., each spot) on the exemplary CCD camera can respond to specific incident angle and specific azymuthal angle without any conversion, which can provide significant improvement on the signal-to-noise ratio and to improve the quality of the holographic scatterometry.

Referring back to FIG. 1, for simplicity, the measurement light 130 is shown focusing onto particular points on the test sample 140, and subsequently interfering with the support beam, i.e., the reflected reference light 120″ on a corresponding spot on the exemplary CCD camera 150. In various embodiments, the CCD camera can be used to collect and measure information integrated from any other points of the test sample for all incident angles and all azymuthal angles.

Geometries and/or feature dimensions of the test sample 140 can then be evaluated based on the holographic results obtained on the screen of the CCD camera. The holographic results (i.e., hologram) can include, for example, an information pattern including both amplitude and phase information for all incident angles and all azymuthal angles from the scattered test light from the measured sample. For example, the pattern-type results of the hologram can be a two-dimensional mixture of dots as opposed to an image illustration of structures/shapes of the test sample in a conventional scatterometry. The holographic results can further be analyzed using standard scatterometric data library to transform scatterometry measurements into geometric measurements.

For example, the holographic scatterometric data library can be established in a standard way based on an analysis of a theoretical model that is defined for various physical structures. The theoretical model can predict the empirical measurements that scatterometry systems would record for the structure. The theoretical results of this calculation can then be compared to the measured data from scatterometric signals. To the extent the results do not match, the theoretical model can be modified, calculated once again and compared to the empirical measurements. This process can be repeated iteratively until the characteristics of the theoretical model and the physical structure are very similar. The scatterometric data library, e.g., a data library including 2-dimensional data patterns, can be established.

By comparing the sample pattern from the holographic information on the exemplary CCD camera with the patterns calculated from the established scatterometric data library, the sample character can be obtained from the best match between the sample hologram and the library hologram. The best fit of the library signature can be “automatically” selected based on amplitude and phase information of the scattered light from the test sample. There is no need to generate two types of libraries for both reflectometer (as for amplitude information) and ellipsometer (as for phase information).

In this manner, the holographic scatterometry system (as shown in FIG. 1) can provide immediate amplitude and phase information from different incident angles and instantaneously collect all information coming out from the target sample at different scattered angles. By combining power of the angular reflectometry and ellipsometry in a single tool to record amplitude and phase of the scattered light, there is no need to analyze polarization of scattered light since holographic scatterometry can provide immediate phase information through the interference from the test light and the reference light that are split from the common incident light. In addition, there are no moving parts in the optical scheme shown in FIG. 1.

In various embodiments, the disclosed holographic scatterometric analysis of a featured object can be used on a real-time basis during, e.g., semiconductor manufacturing, so that manufacturers can immediately determine when a process is not operating correctly. Such need is becoming more acute as the industry moves towards integrated metrology solutions wherein the metrology hardware is integrated directly with the process hardware.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for holographic scatterometry comprising:
providing a test light that is coherent with a reference light, wherein the test light is directed to emerge from a test object; and
bringing the emerged test light and the reference light together on an image sensor to record a holographic information, wherein the holographic information comprises an amplitude information and a phase information of the emerged test light from the test object.

2. The method of claim 1, further comprising recording the amplitude information and the phase information for different azymuthal angles simultaneously and instantaneously on the image sensor.

3. The method of claim 1, further comprising determining a topographic feature of the test object by comparing the recorded holographic information with a single scatterometric data library.

4. The method of claim 1, wherein the holographic information further comprises an all angular resolution in incident and azymuthal directions.

5. The method of claim 1, wherein the test light is directed to emerge from the test object by scattering, diffracting or reflecting the test light.

6. The method of claim 1, wherein the coherent test light and the reference light are derived from a common source, wherein the common source comprises a laser light, a mercury-arc light, a white light or a monochromatic light.

7. The method of claim 1, further comprising splitting an incident light into two coherent lights comprising the test light and the reference light using a beam splitter.

8. The method of claim 7, further comprising,
partially reflecting the incident light to produce the reference light using the beam splitter, and
partially transmitting the incident light to produce the test light using the beam splitter.

9. The method of claim 8, wherein the reference light is reflected by a mirror, transmitted through the beam splitter and interfered with the emerged test light on the image sensor.

10. The method of claim 8, wherein the test light is focused on and emerged from the test object, reflected by the beam splitter and interfered with the reference light on the image sensor.

11. The method of claim 1, wherein the image sensor comprising a charge-coupled device (CCD) camera placed on a focal plane of a light collection optical system for the interfered reference light with the emerged test light.

12. An in-line process analysis for a semiconductor manufacturing using the method of claim 1.

13. A method for holographic scatterometry comprising:
simultaneously recording an amplitude and a phase of a test light caused to emerge from a test object as a holographic pattern using a CCD camera, wherein the test light interferes with a reference light on the CCD camera, the test light and the reference light are derived from a common source; and
comparing the recorded holographic pattern with a data library to determine a topographic feature of the test object.

14. The method of claim 13, wherein the image sensor is a CCD camera placed on the focal plane of a light collection optical system for the interfered test light and the reference light.

15. The method of claim 13, wherein the test light is focused on the test object and scattered, diffracted or reflected from the test object.

16. The method of claim 13, wherein the test light and the reference light are derived by splitting a common incident light using a beam splitter.

17. The method of claim 16, wherein the reference light is partially reflected from the beam splitter, further reflected by a mirror, transmitted by the beam splitter and interfered with the test light on the image sensor.

18. The method of claim 16, wherein the test light is partially transmitted from the beam splitter, focused on the test object, emerged from the test object, reflected by the beam splitter and interfered with the reference light on the image sensor.

19. A holographic scatterometry comprising:
a beam splitter to split an incident light into a reference light and a test light, wherein the test light is focused on and scattered from a test object; and
a CCD camera that is placed on a focal plane of where the scattered test light interferes with the reference light, wherein the CCD camera simultaneously and instantaneously records an amplitude and a phase of the scattered test light from the test object.

20. The scatterometry of claim 19, further comprising a mirror to reflect the reference light that is further transmitted through the beam splitter and interfered with the scattered test light.

21. The scatterometry of claim 19, wherein the incident light is a laser light, a mercury-arc light, a white light or a monochromatic light.

22. The scatterometry of claim 19, further comprising an optical system to focus the test light onto the test object and to propagate the scattered test light back from the test object.

23. The scatterometry of claim 22, wherein the propagated scattered light from the test object is further reflected by the beam splitter onto the CCD camera.
